(19) United States
(12) Patent Application Publication
(10) Pub. No.: US 2007/0257432 A1
(43) Pub. Date: Nov. 8, 2007

(54) Yoga board game and methods of teaching yoga

(75) Inventor: Marita Gardner-Anopol, Kingwood, TX (US)

Correspondence Address: The Wendt Firm, P.C., 34 Driftoak Circle, The Woodlands, TX, 77381, US

(73) Assignee: YOGA 4 KIDS, INC., Kingwood, TX (US)

(21) Appl. No.: 11/418,671

(22) Filed: May 5, 2006

(51) Int. Cl. G09B 9/00; A63B 23/00

(52) U.S. Cl. 273/238; 482/148; 434/1

(57) ABSTRACT

Board games and methods for teaching yoga, especially to children and preteens are described, one board game comprising a die and one or more tokens, and a planar rectangular board having one or more paths for moving the tokens to various positions on the board based on rolling the die, some of the positions indicating to the player to form a yoga body posture, and others instructing the player to choose a card from a set of cards, each card comprising instructions on a yoga technique. This abstract allows a searcher or other reader to quickly ascertain the subject matter of the disclosure. It may not be used to interpret or limit the scope or meaning of the claims. 37 CFR 1.72(b).

### BACKGROUND OF THE INVENTION

1. Field of Invention

The present invention generally relates to yoga. More particularly, the present invention relates to board games for teaching yoga, especially to children.

2. Related Art

Children and teenagers today, at least in the more affluent, technology advanced countries, are bombarded by information from electronic gadgets, such as television, personal music players, computer and video games, cellular telephones, text messaging, and a host of other distractions. Many students must use computers and the Internet simply to download and turn in their homework. While these conveniences may be advances in terms of communication and ease of access to online music, video, and knowledge resources, many believe they result in lack of concentration, difficulty in school, and general malaise. To remedy this situation, many have recommended yoga.

In the West, hatha yoga has become wildly popular as a purely physical exercise regimen divorced of its original purpose. Currently, it is estimated that about 30 million Americans practice hatha yoga. Western development of yoga has taken less of a spiritual approach and focused more on the mind/body connection. While Yoga is a religion to many, most practitioners in the west separate yoga from their spiritual beliefs, causing yoga to stay strictly within the parameters of an exercise/fitness regimen, or an overall program of keeping physically and emotionally healthy.

Hatha yoga, also known as Hatha vidya, is a particular system of Yoga introduced by Yogi Swatmarama, a yogic sage of the 15th century in India, and compiler of the Hatha Yoga Pradipika. Hatha Yoga is derived from the Hinayana (narrow path) and Mahayana (great path) traditions of Buddhism, as well as the Sahajayana (spontaneous path) and Vajrayana (concerning matters of sexuality) traditions of Tantra. The Hatha Yoga of Swatmarama and his contemporaries differs from the Raja Yoga of Patanjali in that it focuses on shatkarma, the purification of the physical as leading to the purification of the mind (ha) and prana, or vital energy (tha). The Raja Yoga posited by Patanjali begins with a purification of the mind (yamas) and spirit (niyamas), then comes to the body via asana (body postures) and pranayama (breath). Hatha Yoga is what most people associate with the word “Yoga” and is mainly practiced for mental, physical health, and vitality outside of India.

Yoga may be one route to getting children and teenagers “unplugged” from external distractions of today's world, leading to more focus, and more healthy bodies and minds. Indeed, in an article in TIME Magazine, February, 2001, an author was quoted as stating, “For stressed out kids, yoga offers the road to inner peace.” However, while there are many who offer yoga classes today, there are very few teaching aids on the market today, aside from a few online kits that might include CD or two, some insense, and cards having yoga poses thereon. Some are dedicated to more adult themes which are inappropriate for children and young adults. What is needed is a challenging, fun, healthy way to teach yoga positions and theories, especially to pre-teen children who are generally open-minded to try new things, generally have the natural physical flexibility to perform the poses easily, and who have not yet become “addicted” to electronic conveniences, as well as to teens who do have trouble focusing and become stressed when tested.

Educational board games exist to teach players finance, real estate, tax and other topics. Children generally love board games, and other inventors have attempted to teach aspects of yoga using board games and flash cards; however, existing yoga board games and flash cards lack sophistication and depth in teaching yoga, and may not be challenging enough or interesting to many children today. It would be a positive advance in teaching yoga to pre-teen children and teens if a board game and method could be developed to increase the students' interest in yoga while remaining challenging, and therefore a better teaching aid, than yoga kits and board games marketed heretofore.

### SUMMARY OF THE INVENTION

In accordance with the present invention, board games and methods of use in teaching yoga are described that are unique in design compared to previously known board games and yoga teaching methods. Children especially love the inventive yoga board game described herein because not only are they allowed to make known yoga poses, in some instances they can make up new yoga poses. This is accomplished by a player rolling a die or dice, and moving a token to a position on the board that instructs the player what pose to imitate, or to make up a new pose. The goal is not to win per se, although the board game may be played in that way; rather, the main goals are to relieve stress and improve physical and mental through yoga poses and breathing techniques, and more importantly learn about your body and improve concentration skills, which may lead to better attitude, more personal confidence, and personal health through a sense of natural growth and accomplishment.

Thus, a first aspect of the invention is a method of teaching yoga comprising:
a) moving a token to various positions on a board based on a random number generated by a player, at least some of the positions indicating to the player to form a yoga body posture, and other positions instructing the player to choose an object having instructions on a yoga technique; and
b) using the information or instructions to form the yoga body posture or try the yoga technique.

As used herein, “yoga body posture” means the physical form a player's body assumes, while “yoga technique” includes a yoga posture but also may include a way of breathing and/or meditating while forming the pose. Methods within the invention include those wherein the random number is generated by an action selected from throwing of a die, throwing of a pair of dice, spinning a spinner, actuating an electronic random number picker, or similar functioning random number generator, and the like. While technically there is no upper limit to the random number generated, the random number generated may range from 1 to 50, or from 1 to 20, or from 1 to 5. Certain methods of the invention comprise the player reading instructions printed on or illuminated from the object, such as when the object is a card or an electronic display; reading instructions contained within the object, such as when the object is an edible or non-edible device, such as a fortune cookie or some other shaped form that can be opened to reveal instructions either on a piece of the object or on a scrap of paper or an edible item inside the object; or projected from the object, such as when the object is electronic in nature and is able to project words or symbols onto a wall or piece of paper, for example. In certain embodiments, the methods comprise the player reading about one or two benefits or attributes of the particular yoga body posture or yoga technique called for in the instructions on or in the object, for example, strengthening the back and stretching the shoulders and arms, and opening the chest for better breathing. In certain embodiments, the player may review a picture or sketch of a child or teenager assuming the body posture, along with written information on how to breathe and/or meditate during the pose. The picture or sketch may be on the same side of the object as the instructions, or may be on any side or surface of the object, such as a reverse side when the object is a card, or projected onto a wall or other surface. In certain embodiments the picture or sketch may be a colorful drawing of a child or teen striking the pose called for on the object, and the objects may have color schemes depending on the type of pose, for example an animal poses might be one color or color scheme, while inanimate object poses, such as a mountain pose and a bow pose, may be another color or color scheme. In exemplary embodiments, the reading of the instructions on or in the object may comprise the player breathing in a certain way, for example breathing in and out of the nose slowly and deeply, or holding a pose and/or breathing a certain way for a certain time period, such as 10 to 30 seconds.

A second aspect of the invention is a board game (could claim as a kit claim) comprising:
a) a random number generator and one or more tokens;
b) a board having one or more paths for moving the tokens, the paths having various positions adapted to accept tokens indicating a player's movements on the board based on a random number generated by the random number generator by a player, at least some of the positions indicating to the player to form a yoga body posture, and other positions instructing the player to choose an object having instructions on a yoga technique; and
c) a set of objects having instructions on a yoga technique.

As used herein the term “board” is a generic term and means any two- or three-dimensional shaped form, which may be planar or non-planar. Planar shaped boards may be selected from, for example but not limited to, rectangular, circular, triangular, elliptical, star shaped, and the like. Non-planar shapes may be selected from, for example but not limited to, spherical, hemispherical, conical, surfaces having multiple levels and/or structures (buildings), topographic structures (for example raised areas or regions mimicking hills or mountains), steps, ramps, and the like, and any combination of these. Materials making up the board may comprise paper, cardboard, metal, plastic, laminates, any composite material, and any combination of these. In certain embodiments the board may include magnets, hook and loop fasteners, and the like, for example should the players wish to place a planar board on a wall and move tokens around the board.

These and other features of the inventive board game and methods of the invention may become more apparent upon review of the brief description of the drawings, the detailed description of the invention, and the claims that follow.

### BRIEF DESCRIPTION OF THE DRAWINGS

The manner in which the objectives of the invention and other desirable characteristics may be obtained is explained in the following description and attached drawings in which:

FIGS. 1 and 2 are plan views of a portion of a planar board for use in one embodiment of the invention;

FIGS. 3A and 3B are copies of front and back, respectively. of a card useful in one embodiment of the invention; and

FIGS. 4A and 4B are copies of front and back, respectively, of another card useful in one embodiment of the invention.

It is to be noted, however, that the appended drawings are not to scale and illustrate only typical embodiments of this invention, and are therefore not to be considered limiting of its scope, for the invention may admit to other equally effective embodiments.

### DETAILED DESCRIPTION

In the following description, numerous details are set forth to provide an understanding of the present invention. However, it may be understood by those skilled in the art that the present invention may be practiced without these details and that numerous variations or modifications from the described embodiments may be possible.

All phrases, derivations, collocations and multiword expressions used herein, in particular in the claims that follow, are expressly not limited to nouns and verbs. It is apparent that meanings are not just expressed by nouns and verbs or single words. Languages use a variety of ways to express content. The existence of inventive concepts and the ways in which these are expressed varies in language-cultures. For example, many lexicalized compounds in Germanic languages are often expressed as adjective-noun combinations, noun-preposition-noun combinations or derivations in Romanic languages. The possibility to include phrases, derivations and collocations in the claims is essential for high-quality patents, making it possible to reduce expressions to their conceptual content, and all possible conceptual combinations of words that are compatible with such content (either within a language or across languages) are intended to be included in the used phrases.

As noted previously, existing yoga board games and flash cards lack sophistication and depth in teaching yoga, and may not be challenging enough or interesting to many children today. On the other hand, many yoga teaching kits may not be appropriate for children. It would be a positive advance in teaching yoga to pre-teen children and teens if a board game and method could be developed to increase the students' interest in yoga while remaining challenging, and therefore a better teaching aid, than yoga kits and board games marketed heretofore. The board games and methods of teaching yoga of the present invention address these problems.

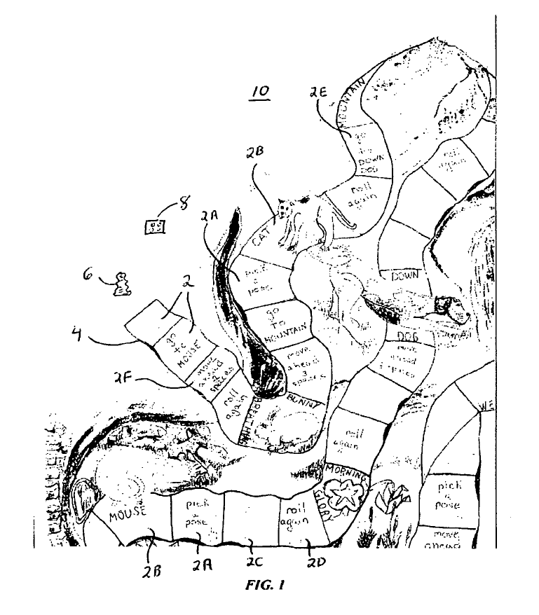

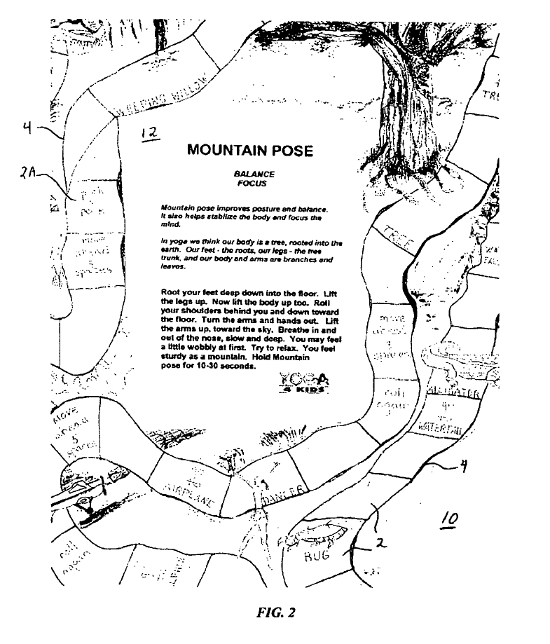

Referring now to the drawings figures, which are not necessarily to scale, FIGS. 1 and 2 are plan view illustrations of two different portions of a two-dimensional planar board 10 for use in one embodiment of the invention. It must be emphasized once again that planar, two-dimensional boards are merely one version of a board useful in the invention. Illustrated in both FIGS. 1 and 2 are a plurality of positions 2 on a path 4 where a token 6 might land after a random number is generated, for example by a player rolling a die 8. As may be seen in FIGS. 1 and 2, there are a variety of positions on board 10: position 2A calls for the player to “pick a pose”, in this embodiment of the game off of a stack of cards 12, as illustrated in FIG. 2; position 2B informs the player to form a particular pose represented by words and a sketch of the position, for example a mouse or “down dog”; position 2C is a rest position; position 2D asks the player to roll again; position 2E instructs the player to go to another position on the board; and position 2F instructs the player to move a number of spaces ahead. Other positions with other instructions will be apparent to persons of ordinary skill in the board game art, and are considered within the invention.

Position 2A, “pick a pose” is an important yoga learning aspect of the methods and board games of the invention, as these positions instruct the player to choose an object, in this embodiment a card, having information and instructions on a particular pose to form. The objects may be a stack of cards 12 placed directly on board 10 so that path 4 winds around the stack of cards, such as illustrated in FIG. 2, but the invention is not so limited. Stack of cards 12 may be held in a box for the board game, or in the hands of a supervisor or yoga instructor, or any other format imaginable. Examples of other formats might be, for example edible fortune cookies having instruction tickets inside; a bowl of marbles each having a different symbol (number, emblem or the like) corresponding to an instruction printed on a sheet of paper or on the board game box; the player may be instructed to generate another random number which leads to a particular pose to imitate. Essentially any way of making the game fun and instructive may be used at this point of the game.

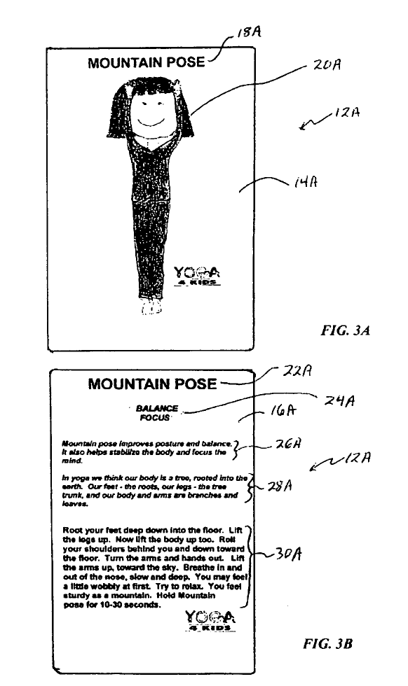

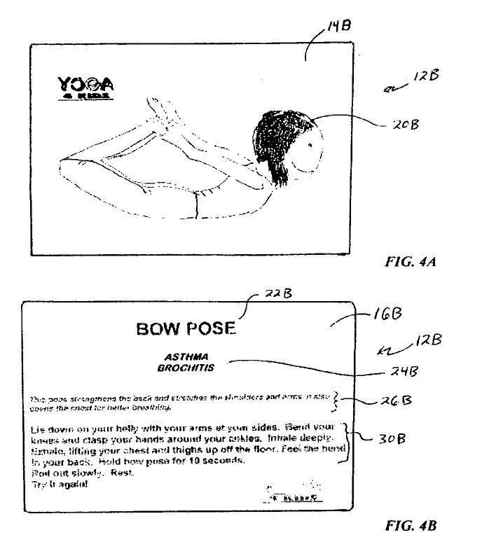

FIGS. 3A and 3B are copies of front and back, respectively of one card object 12A useful in one embodiment of the invention, and FIGS. 4A and 4B are copies of front and back, respectively of another card object 12B useful in one embodiment of the invention. As to which side is the front and which side is the back of a card, this is arbitrary. FIG. 3A illustrates a front side 14A of card 12A, and FIG. 3B a back side 16A of card 12A, while FIG. 4A illustrates a front side 14B of card 12B, and FIG. 4B a back side 16B of card 12B. There may be as few or as many objects as the players wish to use. There is no upper limit; and the minimum number of objects maybe as few as 1. One benefit of using cards as the objects is that they may be “recycled” by placing a card at the bottom of the deck, whereas if edible objects are use, there may need to be sufficient objects on hand to carry out a game for a sufficient time.

Reviewing cards 12A and 12B more closely, FIG. 3A illustrates a title 18A, in this case “MOUNTAIN POSE”, and a drawing, photo, or sketch of a child 20A performing the pose indicated in title 18A. The cards or other objects may be made colorful, although this is not required. Side 16A of card 12A may also have a title 22A, but also may include written information 24A, 26A, and 28A regarding the benefits of the pose, and/or instructions 30A on how to make the pose. The instructions may include tips on how to breathe while performing the pose. Similar features are illustrated in FIGS. 4A and 4B at 20B, 22B, 24B, 26B, and 30B. Alternatively, instead of having information on both sides of a particular card, the cards may have all of the described features on the same side of the card, with the other side of the card blank, which perhaps allows for an instructor to make notes or jot down other useful information. Those skilled in the art will no doubt be able to envision other objects and features than mentioned herein, and these variations are considered within the scope of the invention.

When referring to materials of construction of the various components, various papers and paperboard products, textiles, and leathers may be envisioned for the board, although metal and plastic boards are not ruled out, as well as boards may from any combination of these. Metals, plastics, and the like may be used for the tokens, or one could even use food items, rocks, pebbles, and the like. Metals, if used, may be selected from steels, including various stainless steels, titanium, beryllium, metal matrix composites, and in certain cases, depending on the component, aluminum, copper, nickel, chrome, brass, aluminum, and the like. For components expected to undergo a lot of stress, such as the tokens and dice or spinners for generating random numbers, if used, steel and titanium may be better choices than aluminum and copper, for example. Suitable plastic materials include high-strength polymeric materials such as thermoplastic elastomers and high-density versions of polyethylene, polypropylene, polyacrylate, polymethyl methacrylate, polycarbonate, polyamide, polyurea, polyurethane, and the like. Board games of the invention may include adhesives, colorful tape, and a variety of color schemes, especially those conducive to learning yoga.

In conclusion, board games and methods of teaching yoga of the invention solve many of the problems that exist with currently available yoga kits and board games in a unique way of teaching that may benefit anyone who desires to improve focus, flexibility, concentration and other benefits of yoga. Although only a few exemplary embodiments of this invention have been described in detail above, those skilled in the art may readily appreciate that many modifications are possible in the exemplary embodiments without materially departing from the novel teachings and advantages of this invention. For example, the board games may include music on tapes, compact disks, or any other format, but these are not required. Accordingly, all such modifications are intended to be included within the scope of this invention as defined in the following claims. In the claims, no clauses are intended to be in the means-plus-function format allowed by 35 U.S.C. § 112, paragraph 6 unless “means for” is explicitly recited together with an associated function. “Means for” clauses are intended to cover the structures described herein as performing the recited function and not only structural equivalents, but also equivalent structures.

What is claimed is:

1. A method comprising:
a) moving a token to various positions on a board based on a random number generated by a player, at least some of the positions indicating to the player to form a yoga body posture, and other positions instructing the player to choose an object having instructions on a yoga technique; and
b) using the information or instructions to form the yoga body posture or try the yoga technique.

2. The method of claim 1 wherein the random number is generated by an action selected from throwing of a die, throwing of a pair of dice, spinning a spinner, actuating an electronic random number picker, similar functioning random number generator, and the like.

3. The method of claim 1 wherein the random number generated ranges from 1 to 50.

4. The method of claim 1 comprising the player reading instructions printed on or illuminated from the object.

5. The method of claim 4 wherein reading instructions comprises steps selected from reading a card, reading an electronic display, reading instructions contained within or on a piece of the object when the object is an edible or non-edible device, and reading instructions projected from the object.

6. The method of claim 1 comprising the player reading about at least one benefit or attribute of the particular yoga body posture or yoga technique called for in the instructions on or in the object.

7. The method of claim 1 comprising the player reviewing a picture, photo, drawing, or sketch of a child or teenager assuming the body posture, along with written information on how to breathe and/or meditate during the pose.

8. The method of claim 7 wherein the picture, photo, drawing or sketch is selected from being on the same side of the object as the instructions, being on any side or surface of the object, and projected onto a wall or other surface.

9. The method of claim 7 wherein the picture, photo, drawing or sketch is a colorful drawing of a child or teen striking the pose called for on the object.

10. The method of claim 1 wherein the objects have color schemes depending on the type of pose.

11. The method of claim 1 wherein the reading of the instructions on or in the object comprises the player reading instructions on breathing in a certain way during the forming of the yoga body posture or trying the yoga technique.

12. A board game comprising:
a) a random number generator and one or more tokens;
b) a board having one or more paths for moving the tokens, the paths having various positions adapted to accept tokens indicating a player's movements on the board based on a random number generated by the random number generator by a player, at least some of the positions indicating to the player to form a yoga body posture, and other positions instructing the player to choose an object having instructions on a yoga technique; and
c) a set of objects having instructions on a yoga technique.

13. The board game of claim 12 wherein the board is selected from two-dimensional and three-dimensional shaped forms.

14. The board game of claim 13 wherein the two-dimensional shaped forms are selected from rectangular, circular, triangular, elliptical, and star shaped, and the three-dimensional shaped forms are selected from spherical, hemispherical, conical, surfaces having multiple levels and/or structures, topographic structures, and any combination of these.

15. The board game of claim 12 wherein the random number generator is selected from a die, a pair of dice, a spinner, an electronic random number picker, or similar functioning random number generator.

16. The board game of claim 12 wherein the object comprises instructions printed on at least one side of the object or a piece of the object and/or illuminated from the object.

17. The board game of claim 12 wherein the object comprises a picture, photo, drawing, or sketch of a child or teenager assuming the body posture, along with written information on how to breathe and/or meditate during the pose.

18. The board game of claim 12 wherein materials making up the board are selected from paper, cardboard, metal, plastic, laminates, magnets, hook and loop fasteners, any composite material, and any combination of these.

19. A board game comprising:
a) a die and one or more tokens;
b) a planar rectangular board having one or more paths for moving the tokens, the paths having various positions adapted to accept the tokens indicating a player's movements on the board based on a random number generated by a player rolling the die, at least some of the positions indicating to the player to form a yoga body posture, and other positions instructing the player to choose a card from a set of cards positioned on the board in a stack, each card comprising instructions on a yoga technique including a picture, photo, drawing, or sketch of a child or teenager assuming the body posture indicated on the card, the card also comprising written information on how to breathe and/or meditate during the pose, and explaining one or two expected physical and/or psychological benefits from practicing the pose.

20. The board game of claim 19 wherein each card comprises a color scheme depending on the type of pose illustrated on the card.
